(19) United States
(12) Patent Application Publication
(10) Pub. No.: US 2010/0084558 A1
(43) Pub. Date: Apr. 8, 2010

(54) SYSTEMS AND METHODS FOR DETERMINING A CONCENTRATION OF UREA IN AN AQUEOUS SOLUTION

(76) Inventors: Su-Chee S. Wang, Troy, MI (US); Christopher M. Thrush, Shelby Township, MI (US); Yingjie Lin, El Paso, TX (US)

Correspondence Address: DELPHI TECHNOLOGIES, INC;LEGAL STAFF - M/C 483-400-402, 5725 DELPHI DRIVE, PO BOX 5052, TROY, MI, 48007, US

(21) Appl. No.: 12/244,457

(22) Filed: Oct. 2, 2008

(51) Int. Cl. G01N 31/00; G01J 5/02

(52) U.S. Cl. 250/339.11; 702/25; 250/341.8

(57) ABSTRACT

System and methods for determining a concentration of urea in an aqueous solution disposed in a container are provided. The system includes an infrared light source and an infrared light detector. The system further includes a window disposed proximate to an aperture of the container, such that the infrared light at a first light intensity level from the infrared light source passes through a first portion of the window toward the aqueous solution. A portion of the infrared light is absorbed by the aqueous solution, and a second portion of the infrared light is reflected from the aqueous solution and through a second portion of the window. The infrared light detector system generates a first signal indicative of a second light intensity level based on the second portion of infrared light. The system further includes a microprocessor that determines the second light intensity level based on the first signal, and further determines a urea concentration based on the first and second light intensity levels.

### BACKGROUND

Selective Catalytic Reduction (SCR) systems have been introduced to reduce NOₓ emissions from diesel engines. The SCR systems pump a urea solution from a urea tank into a vehicle exhaust system to reduce the NOₓ emissions. However, vehicle operators may add water to the urea tank to reduce operational costs, which may impair the operation of the SCR system.

Accordingly, the inventors herein have recognized a need for an improved system and method for determining a concentration of urea.

### SUMMARY OF THE INVENTION

A system for determining a concentration of urea in an aqueous solution disposed in a container in accordance with an exemplary embodiment is provided. The system includes an infrared light source configured to emit infrared light having a predetermined wave number at a first light intensity level. The system further includes a window disposed proximate to an aperture of the container, such that the infrared light from the infrared light source passes through a first portion of the window toward the aqueous solution. A first portion of the infrared light is absorbed by the aqueous solution, and a second portion of the infrared light is reflected from the aqueous solution and through a second portion of the window. The system further includes an infrared light detector configured to receive the second portion of the infrared light and to generate a first signal indicative of a second light intensity level based on the second portion of infrared light. The system further includes a microprocessor operably coupled to the infrared light detector configured to receive the first signal and to determine the second light intensity level based on the first signal. The microprocessor is further configured to determine a concentration value indicative of the concentration of urea in the aqueous solution based on the first light intensity level and the second light intensity level.

A method for determining a concentration of urea in an aqueous solution disposed in a container in accordance with another exemplary embodiment is provided. The method includes emitting infrared light having a predetermined wave number at a first light intensity level from an infrared light source. The method further includes receiving the infrared light at a window disposed proximate to an aperture of the container, such that the infrared light from the infrared light source passes through a first portion of the window toward the aqueous solution. The method further includes absorbing a first portion of infrared light by the aqueous solution. The method further includes reflecting a second portion of the infrared light from the aqueous solution through a second portion of the window. The method further includes receiving the second portion of the infrared light at an infrared light detector and generating a first signal indicative of a second light intensity level based on the second portion of the infrared light, utilizing the infrared light detector. The method further includes determining the second light intensity level based on the first signal utilizing a microprocessor operably coupled to the infrared light detector. The method further includes determining a concentration value indicative of the concentration of urea in the aqueous solution based on the first light intensity level and the second light intensity level. The method further includes storing the concentration value in a memory device.

A system for determining a concentration of urea in an aqueous solution disposed in a container in accordance with another exemplary embodiment is provided. The system includes an infrared light source configured to emit infrared light having a predetermined wave number at a first light intensity level. The system further includes a window disposed proximate to an aperture of the container, such that the infrared light from the infrared light source enters the window. The infrared light passes through a first portion of the window toward the aqueous solution. A first portion of the infrared light is absorbed by the aqueous solution, and a second portion of the infrared light is reflected from the aqueous solution through a second portion of the window. The second portion of the infrared light reflects from an outer surface of the window toward the aqueous solution. A third portion of the infrared light is absorbed by the aqueous solution, and a fourth portion of the infrared light is reflected from the aqueous solution through a third portion of the window. The system further includes an infrared light detector configured to receive the fourth portion of the infrared light and to generate a first signal indicative of a second light intensity level based on the fourth portion of the infrared light. The system further includes a microprocessor operably coupled to the infrared light detector configured to receive the first signal and to determine the second light intensity level based on the first signal. The microprocessor is further configured to determine a concentration value indicative of the concentration of urea in the aqueous solution based on the first light intensity level and the second light intensity level.

### BRIEF DESCRIPTION OF THE DRAWINGS

FIG. 1 is a schematic of a system for determining a concentration of urea in an aqueous solution disposed in a container in accordance with an exemplary embodiment;

FIG. 2 is a graph indicating absorbance characteristics of infrared light in both water and urea;

FIG. 3 is a graph indicating absorbance values for infrared light in both water and urea;

FIG. 4 is a table indicating absorbance values for infrared light having a single reflection in an aqueous solution having urea therein;

FIGS. 5-6 are flowcharts of a method for determining a concentration of urea in an aqueous solution disposed in a container in accordance with another exemplary embodiment;

FIG. 7 is a schematic of a pair of windows being formed from a substrate;

FIG. 8 is a schematic of a system for determining a concentration of urea in an aqueous solution disposed in a container in accordance with another exemplary embodiment;

FIG. 9 is a table indicating absorbance values for infrared light having a double reflection in an aqueous solution with urea; and

FIGS. 10-11 are flowcharts of a method for determining a concentration of urea in an aqueous solution disposed in a container in accordance with another exemplary embodiment.

### DETAILED DESCRIPTION OF EXEMPLARY EMBODIMENTS

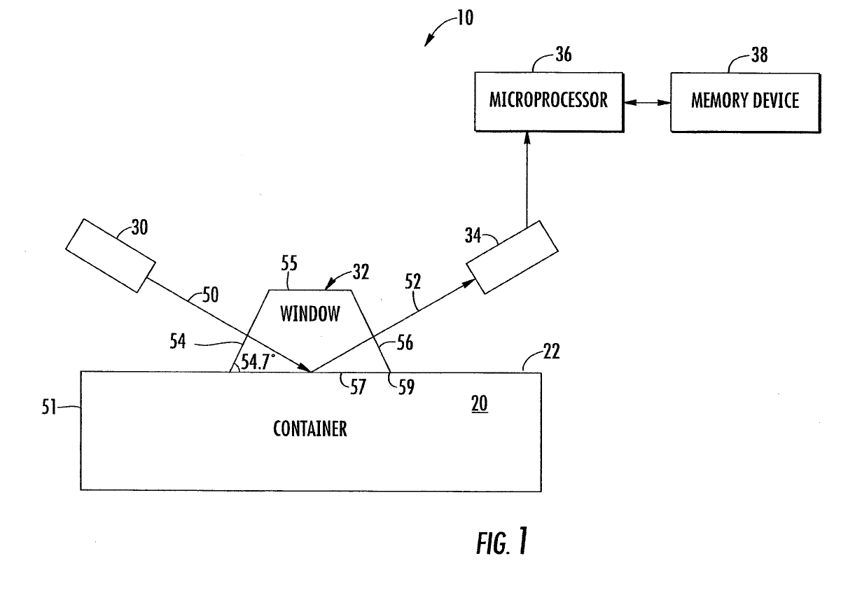

Referring to FIG. 1, a system 10 for determining a concentration of urea an aqueous solution 20 in a container 22 is illustrated. The system 10 includes an infrared light source 30, a window 32, an infrared light detector 34, a microprocessor 36, and a memory device 38.

Referring to FIG. 1, the infrared light source 30 is provided to emit infrared light toward the window 32. In one exemplary embodiment, the infrared light source 30 is configured to emit infrared light having a wave number of 1150. In an alternative embodiment, the infrared light source 30 is configured to emit infrared light having a wave number of 1460. Of course, in other alternative embodiments, the infrared light source 30 is configured to emit infrared light having a wave number other than 1150 or 1460.

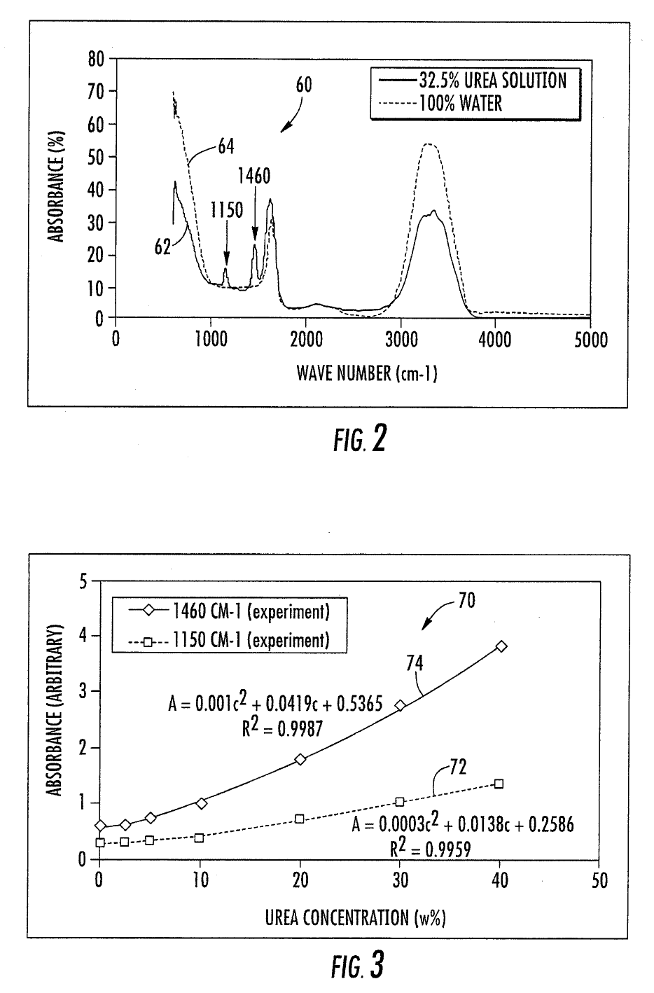

Referring to FIG. 2, a graph having curves 62 and 64 indicating absorbance characteristics of infrared light in urea and water, respectively, is illustrated. In particular, the curve 62 indicates urea solution has an increased absorbance of the infrared light when the wave number of the infrared light is either 1150 or 1460, which does not occur in the curve 64 relating to water. Accordingly, the inventors herein have recognized that a measured absorbance of infrared light when the wave number of the infrared light is either 1150 or 1460 can be utilized to distinguish urea concentrations from water concentrations.

Referring to FIG. 1, the window 32 is coupled to the container 22 over an aperture 59 extending through a wall of the container 22. The window 32 is configured to allow the infrared light from the infrared light source 32 to pass therethrough such that the infrared light contacts the aqueous solution 20 in the container 22. The aqueous solution 20 contains water and urea therein. In one exemplary embodiment, the window 32 has a trapezoidal cross-sectional shape having surfaces 54, 55, 56, 57. The angle between the surface 54 and the surface 57 is in a range of 44.7-64.7 degrees and an angle between the surface 57 and the surface 56 is in a range of 44.7-64.7 degrees. In particular, in one exemplary embodiment, the angle between the surface 54 and the surface 57 is 54.7 degrees and the angle between the surface 57 and surface 56 is 54.7 degrees. The surfaces 55 and 57 are parallel to one another. During use, infrared light 50 from the infrared light source 30 passes through the surface 54 and through a first portion of the window toward the aqueous solution 20. A first portion of the infrared light is absorbed by the aqueous solution 20, and a second portion 52 of the infrared light is reflected from the aqueous solution 20 and through a second portion of the window and out of the surface 56 toward the infrared light detector 34. The window 32 can be constructed from silicon or diamond for example.

The infrared light detector 34 is configured to receive the second portion 52 of infrared light from the window 30 and to generate a signal indicative of a light intensity level based upon the second portion 52 of the infrared light.

The microprocessor 36 operably communicates with the infrared light detector 34. The microprocessor 36 is configured to receive the signal from the infrared light detector 34 and to determine the second light intensity level based on the signal. The microprocessor 36 is further configured to determine a concentration value indicative of the concentration of urea in the aqueous solution based on the first light intensity level and the second light intensity level. In particular, the microprocessor 36 determines an absorbance value A indicating an absorbance of the infrared light by the urea in the aqueous solution 20 utilizing the equation: A=−log(T/T₀) wherein T corresponds to the intensity of the reflected portion 52 of infrared light;

T₀ corresponds to the intensity of the infrared light 50.

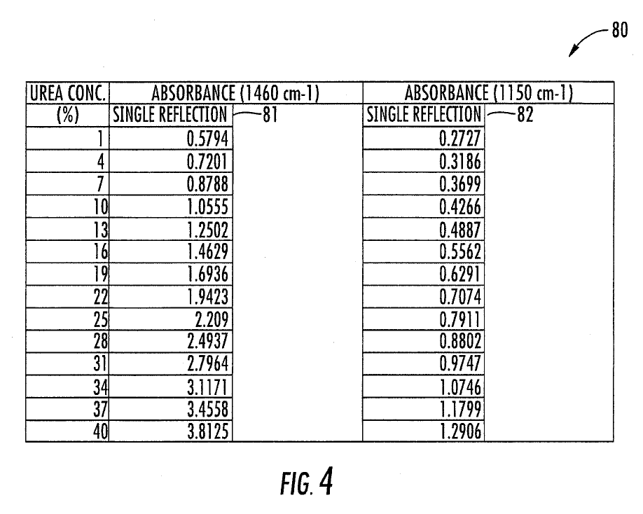

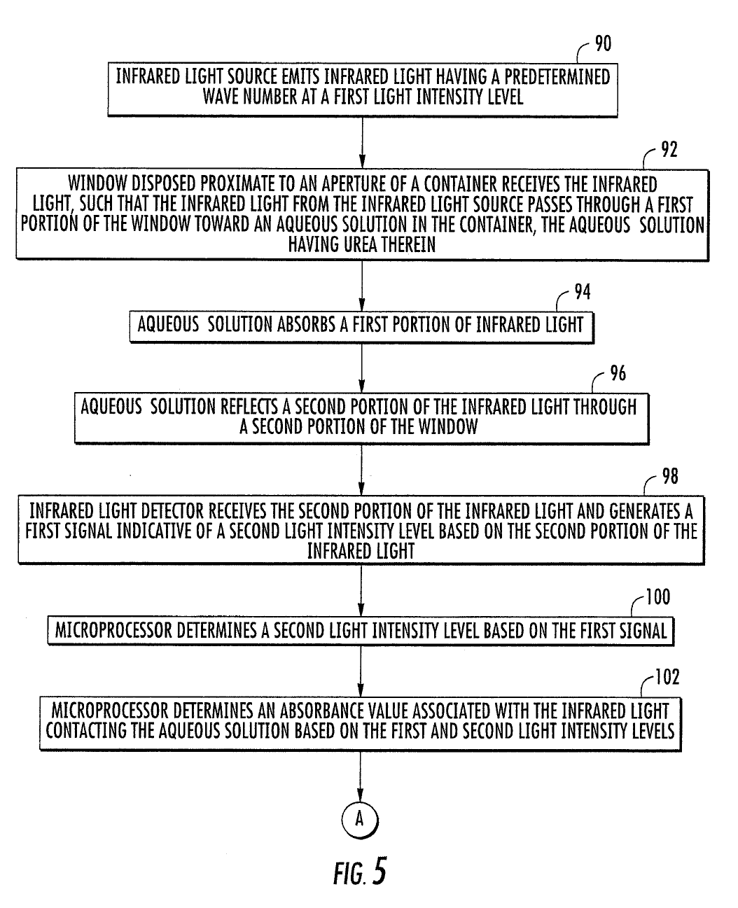

Referring to FIG. 3, after determining the absorbance value, in one exemplary embodiment, the microprocessor 36 determines a concentration value indicative of the concentration of urea in the aqueous solution 20 utilizing a table corresponding to a curve 72 in a graph 70 when infrared light having a wave number of 1150 is the emitted from the infrared light source 30. In another exemplary embodiment, the microprocessor 36 determines the concentration value indicative of the concentration of urea in the aqueous solution 20 utilizing a table corresponding to a curve 74 in the graph 70 when infrared light having a wave number of 1460 is the emitted from the infrared light source 30. Referring to FIG. 4, in yet another exemplary embodiment, the microprocessor 36 determines the concentration value indicative of the concentration of urea in the aqueous solution 20 utilizing data in a column 81 of a table 80 when infrared light having a wave number of 1460 is the emitted from the infrared light source 30. For example, if the absorbance is 0.7201, the urea concentration is 4%. In yet another exemplary embodiment, the microprocessor 36 determines the concentration value indicative of the concentration of urea in the aqueous solution 20 utilizing data in a column 82 of a table 80 when infrared light having a wave number of 1150 is the emitted from the infrared light source 30. After determining the concentration value, the microprocessor 36 stores the concentration value in the memory device 38.

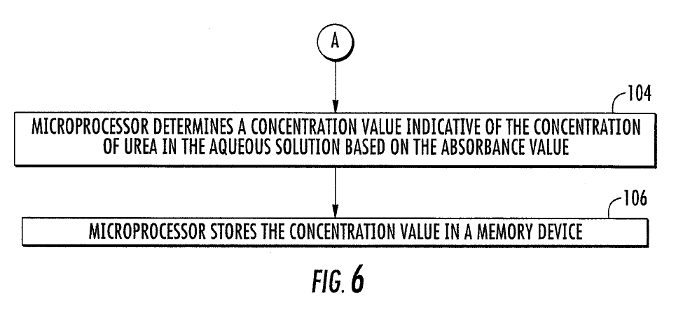

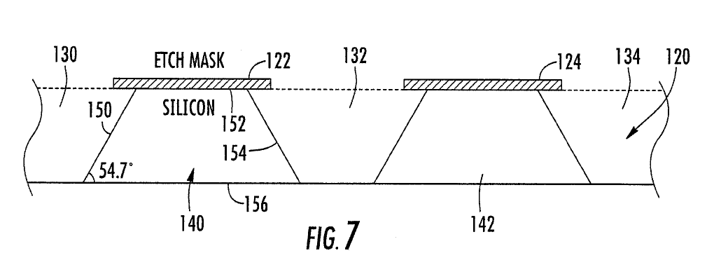

Referring to FIGS. 5 and 6, a flowchart of a method for determining a concentration of urea in an aqueous solution disposed in the container 22 utilizing the system 10 will now be explained. In particular, the system 10 utilizes a single reflection from the aqueous solution 20 to determine an amount of absorbance of infrared light by the aqueous solution 20. The amount of absorbance of infrared light by the aqueous solution 20 is used to determine the urea concentration.

At step 90, the infrared light source 30 emits infrared light having a predetermined wave number at a first light intensity level.

At step 92, the window 32 disposed proximate to the aperture 59 of the container 22 receives the infrared light 50, such that the infrared light 50 from the infrared light source 30 passes through a first portion of the window 32 toward the aqueous solution 20 in the container 22. The aqueous solution 20 has urea therein.

At step 94, the aqueous solution 20 absorbs a first portion of the infrared light 50.

At step 96, the aqueous solution 50 reflects a second portion 50 of the infrared light through a second portion of the window 32.

At step 98, the infrared light detector 34 receives the second portion 52 of the infrared light and generates a first signal indicative of a second light intensity level based on the second portion 52 of the infrared light.

At step 100, the microprocessor 36 determines a second light intensity level based on the first signal.

At step 110, the microprocessor 36 determines an absorbance value associated with the infrared light contacting the aqueous solution 20 based on the first and second light intensity levels.

At step 104, the microprocessor 36 determines a concentration value indicative of the concentration of urea in the aqueous solution 20 based on the absorbance value.

At step 106, the microprocessor 36 stores the concentration value in the memory device 38.

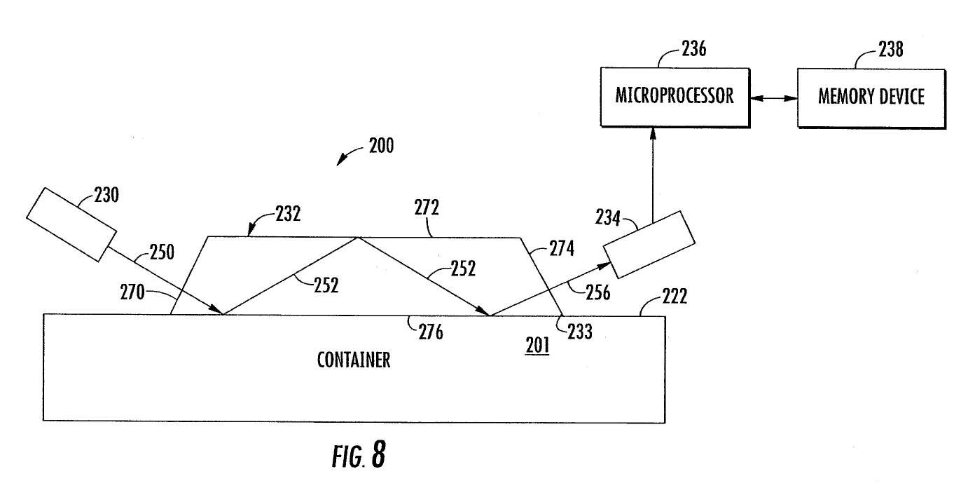

Referring to FIG. 7, a brief explanation of an exemplary chemical process for manufacturing windows for receiving infrared light will now be provided. A silicon substrate 120 has etch masks 122, 124 disposed thereon. A solution of potassium hydroxide can be applied to the silicon substrate 120 such that the regions 130, 132, 134 of the silicon substrate 120 are removed between the etch masks 122, 124. As a result, a window 140 is formed having surfaces 150, 152, 154, 156. Further, a window 142 is formed.

In an alternative mechanical process, a CNC machine (not shown) can be utilized to remove the regions 130, 132, 134 of the silicon substrate 120 to obtain the surfaces 150, 152, 154, 156 of the window 140. Further, the etch masks 122, 124 would not be needed on the silicon substrate 120.

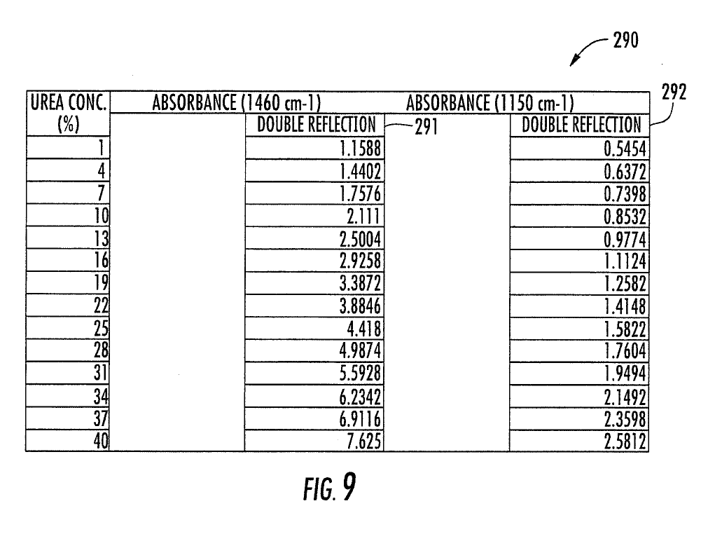

Referring to FIG. 8, a system 200 for determining a concentration of urea in an aqueous solution 201 in a container 222 in accordance with another exemplary embodiment is illustrated. The system 200 includes an infrared light source 230, a window 232, an infrared light detector 234, a microprocessor 236, and a memory device 238.

The window 232 is coupled to the container 222 over an aperture 233 extending through a wall of the container 222. The window 232 is configured to allow the infrared light 250 from the infrared light source 232 to pass therethrough such that the infrared light contacts the aqueous solution 201 at two locations in the container 222. In one exemplary embodiment, the window 232 has a trapezoidal cross-sectional shape having surfaces 270, 272, 274, 276. The angle between the surface 270 and the surface 276 is in a range of 44.7-64.7 degrees and an angle between the surface 276 and surface 274 is in a range of 44.7-64.7 degrees. In particular, in one exemplary embodiment, the angle between the surface 270 and the surface 276 is 54.7 degrees and the angle between the surface 276 and surface 274 is 54.7 degrees. The surfaces 272 and 276 are parallel to one another. During use, infrared light 250 from the infrared light source 230 passes through the surface 270 and through a first portion of the window 232 toward the aqueous solution 201. A first portion of the infrared light is absorbed by the aqueous solution 201. A second portion 252 of the infrared light is reflected from the aqueous solution 201 through a second portion of the window 232. Thereafter, the second portion 252 of the infrared light reflects from an outer surface 272 of the window 232 toward the aqueous solution 201. A third portion of the infrared light is absorbed by the aqueous solution 201. A fourth portion 256 of the infrared light is reflected from the aqueous solution 201 through a third portion of the window 232 toward the infrared light detector 234.

The infrared light detector 234 is configured to receive the second portion 256 of infrared light from the window 232 and to generate a signal indicative of a light intensity level based upon the second portion 256 of the infrared light.

The microprocessor 236 operably communicates with the infrared light detector 234. The microprocessor 236 is configured to receive the signal from the infrared light detector 234 and to determine a second light intensity level based on the signal. The microprocessor 236 is further configured to determine a concentration value indicative of the concentration of urea in the aqueous solution 201 based on the first light intensity level and the second light intensity level. In particular, the microprocessor 236 determines an absorbance value A indicating an absorbance of the infrared light by the urea in the aqueous solution 201 utilizing the equation: A=−log(T/T₀) wherein T corresponds to the intensity of the reflected portion 256 of infrared light;

T₀ corresponds to the intensity of the portion 250 of infrared light.

Referring to FIG. 9, in one exemplary embodiment, the microprocessor 236 determines a concentration value indicative of the concentration of urea in the aqueous solution 201 utilizing data in a column 291 of a table 290 when infrared light having a wave number of 1460 is the emitted from the infrared light source 230. In yet another exemplary embodiment, the microprocessor 236 determines the concentration value indicative of the concentration of urea in the aqueous solution 201 utilizing data in a column 292 of the table 290 when infrared light having a wave number of 1150 is the emitted from the infrared light source 230. After determining the concentration value, the microprocessor 236 stores the concentration value in the memory device 238.

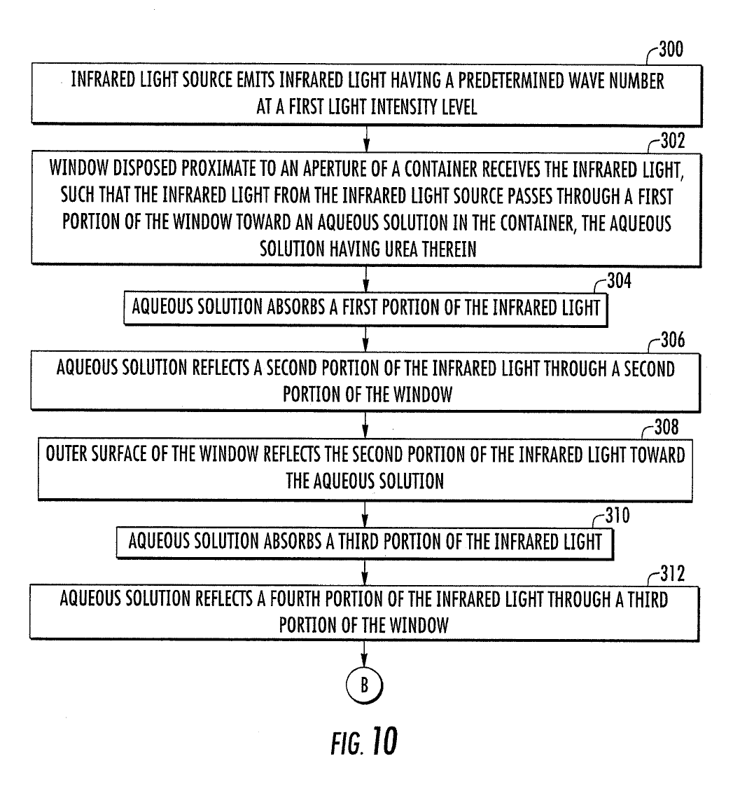

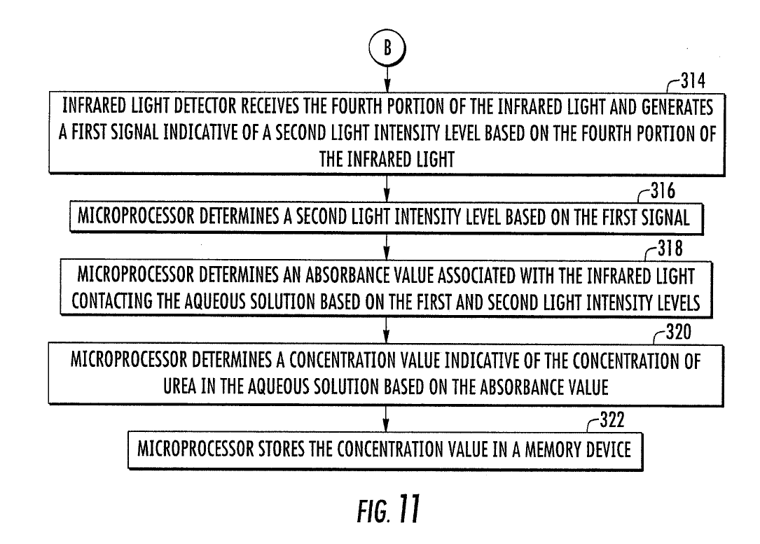

Referring to FIGS. 10 and 11, a flowchart of a method for determining a concentration of urea in an aqueous solution 201 disposed in the container 222 utilizing the system 200 will now be explained. In particular, the system 200 utilizes a double reflection of infrared light from the aqueous solution 201 to determine an amount of absorbance of the aqueous solution 201. The amount of absorbance of the infrared light is utilized to determine the urea concentration.

At step 300, the infrared light source 230 emits infrared light 250 having a predetermined wave number at a first light intensity level.

At step 302, a window 232 disposed proximate to the aperture 233 of the container 222 receives the infrared light 250, such that the infrared light 250 from the infrared light source 230 passes through a first portion of the window 232 toward the aqueous solution 201 in the container 222. The aqueous solution 201 has urea therein.

At step 304, the aqueous solution 201 absorbs a first portion of the infrared light 250.

At step 306, the aqueous solution 201 reflects a second portion 252 of the infrared light through a second portion of the window 232.

At step 308, the outer surface 272 of the window 232 reflects the second portion 252 of the infrared light toward the aqueous solution 201.

At step 310, the aqueous solution 201 absorbs a third portion of the infrared light.

At step 312, the aqueous solution 201 reflects a fourth portion 256 of the infrared light through a third portion of the window 232.

At step 314, the infrared light detector 234 receives the fourth portion 256 of the infrared light and generates a first signal indicative of a second light intensity level based on the fourth portion 256 of the infrared light.

At step 316, the microprocessor 236 determines a second light intensity level based on the first signal.

At step 318, the microprocessor 236 determines an absorbance value associated with the infrared light contacting the aqueous solution 201 based on the first and second light intensity levels.

At step 320, the microprocessor 236 determines a concentration value indicative of the concentration of urea in the aqueous solution 201 based on the absorbance value.

At step 322, the microprocessor 236 stores the concentration value in the memory device 238.

The systems and methods for determining a urea concentration in an aqueous solution provide a substantial advantage over other systems and methods. In particular, the systems and methods provide a technical effect of accurately determining a urea concentration in an aqueous solution utilizing infrared light.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling within the scope of the intended claims. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A system for determining a concentration of urea in an aqueous solution disposed in a container, comprising:
an infrared light source configured to emit infrared light having a predetermined wave number at a first light intensity level;
a window disposed proximate to an aperture of the container, such that the infrared light from the infrared light source passes through a first portion of the window toward the aqueous solution, a first portion of the infrared light being absorbed by the aqueous solution, and a second portion of the infrared light being reflected from the aqueous solution and through a second portion of the window;
an infrared light detector configured to receive the second portion of the infrared light and to generate a first signal indicative of a second light intensity level based on the second portion of infrared light; and
a microprocessor operably coupled to the infrared light detector configured to receive the first signal and to determine the second light intensity level based on the first signal, the microprocessor further configured to determine a concentration value indicative of the concentration of urea in the aqueous solution based on the first light intensity level and the second light intensity level.

2. The system of claim 1, wherein the window comprises a silicon window.

3. The system of claim 1, wherein the window has a trapezoidal cross-sectional shape having first, second, third, and fourth surfaces, the first surface extending between the third and fourth surfaces, the second surface extending between the third and fourth surfaces, the third and fourth surfaces being parallel to one another, the infrared light from the infrared light source passing through the first surface.

4. The system of claim 1, wherein an angle between the first and fourth surfaces are in a range of 44.7-64.7 degrees.

5. The system of claim 4, wherein an angle between the second and fourth surfaces are in a range of 44.7-64.7 degrees.

6. The system of claim 1, wherein the window comprises a diamond window.

7. The system of claim 1, wherein the microprocessor determines the concentration value by:
determining an absorbance value associated with the infrared light contacting the aqueous solution based on the first and second light intensity levels; and
determining the concentration value based on the absorbance value.

8. A method for determining a concentration of urea in an aqueous solution disposed in a container, comprising:
emitting infrared light having a predetermined wave number at a first light intensity level from a infrared light source;
receiving the infrared light at a window disposed proximate to an aperture of the container, such that the infrared light from the infrared light source passes through a first portion of the window toward the aqueous solution;
absorbing a first portion of infrared light by the aqueous solution;
reflecting a second portion of the infrared light from the aqueous solution through a second portion of the window;
receiving the second portion of the infrared light at an infrared light detector and generating a first signal indicative of a second light intensity level based on the second portion of the infrared light, utilizing the infrared light detector;
determining the second light intensity level based on the first signal utilizing a microprocessor operably coupled to the infrared light detector;
determining a concentration value indicative of the concentration of urea in the aqueous solution based on the first light intensity level and the second light intensity level; and
storing the concentration value in a memory device.

9. A system for determining a concentration of urea in an aqueous solution disposed in a container, comprising:
an infrared light source configured to emit infrared light having a predetermined wave number at a first light intensity level;
a window disposed proximate to an aperture of the container, such that the infrared light from the infrared light source enters the window, the infrared light passing through a first portion of the window toward the aqueous solution, a first portion of the infrared light being absorbed by the aqueous solution, and a second portion of the infrared light being reflected from the aqueous solution through a second portion of the window, the second portion of the infrared light reflecting from an outer surface of the window toward the aqueous solution, a third portion of the infrared light being absorbed by the aqueous solution, and a fourth portion of the infrared light being reflected from the aqueous solution through a third portion of the window;
an infrared light detector configured to receive the fourth portion of the infrared light and to generate a first signal indicative of a second light intensity level based on the fourth portion of the infrared light; and
a microprocessor operably coupled to the infrared light detector configured to receive the first signal and to determine the second light intensity level based on the first signal, the microprocessor further configured to determine a concentration value indicative of the concentration of urea in the aqueous solution based on the first light intensity level and the second light intensity level.

10. The system of claim 9, wherein the window comprises a silicon window.

11. The system of claim 9, wherein the window has a trapezoidal cross-sectional shape having first, second, third, and fourth surfaces, the first surface extending between the third and fourth surfaces, the second surface extending between the third and fourth surfaces, the third and fourth surfaces being parallel to one another, the infrared light from the infrared light source passing through the first surface, the first and second surfaces formed by a chemical process or a mechanical process.

12. The system of claim 9, wherein an angle between the first and fourth surfaces are in a range of 44.7-64.7 degrees.

13. The system of claim 12, wherein an angle between the second and fourth surfaces are in a range of 44.7-64.7 degrees.

14. The system of claim 12, wherein the window comprises a diamond window.

15. The system of claim 9, wherein the microprocessor is further configured to determine the concentration value by:
determining an absorbance value associated with the infrared light contacting the aqueous solution based on the first and second light intensity levels; and
determining the concentration value based on the absorbance value.
